(19) United States
(12) Patent Application Publication
(10) Pub. No.: US 2026/0178127 A1
(43) Pub. Date: Jun. 25, 2026

(54) VIBRATION APPARATUS AND METHOD FOR MANUFACTURING THE SAME, AND FLEXIBLE DISPLAY APPARATUS AND VEHICULAR APPARATUS COMPRISING THE VIBRATION APPARATUS

(71) Applicant: LG Display Co., Ltd., Seoul (KR)

(72) Inventor: Kyungyeol Ryu, Paju-si (KR)

(73) Assignee: LG Display Co., Ltd., Seoul (KR)

(21) Appl. No.: 19/396,863

(22) Filed: Nov. 21, 2025

(30) Foreign Application Priority Data
Dec. 24, 2024 (KR) 10-2024-0194888

(51) Int. Cl. G06F 3/01; B60K 35/10; B60K 35/22; B60K 35/25; G06F 3/041

(52) U.S. Cl. CPC G06F 3/016; B60K 35/10; B60K 35/22; B60K 35/25; G06F 3/0412; B60K 2360/119; B60K 2360/1434; B60K 2360/782; B60K 2360/794; G06F 2203/04102

(57) ABSTRACT

A vibration apparatus includes a flexible vibration device including a piezoelectric material, and a shape-maintaining member having a curved portion coupled to a rear surface of the flexible vibration device. The flexible vibration device may be maintained in a curved shape corresponding to the curved portion of the shape-maintaining member.

### CROSS-REFERENCE TO RELATED APPLICATION

This application claims the benefit of and priority to Korean Patent Application No. 10-2024-0194888, filed on Dec. 24, 2024, the entirety of which is hereby incorporated by reference for all purposes as if fully set forth herein.

### BACKGROUND

### Technical Field

The present disclosure relates to a vibration apparatus and a method for manufacturing the same, and to a flexible display apparatus and a vehicular apparatus including the vibration apparatus.

Description of the Related Art

A vibration apparatus is configured to convert an input electrical signal into a physical vibration. The vibration apparatus including a piezoelectric material, such as a piezoelectric ceramic or the like, is lightweight and has low power consumption, and thus is used for various purposes. Recently, a vibration apparatus having a curved shape has been required for some applications.

The vibration apparatus including a piezoelectric material may have a reduced piezoelectric constant due to stress applied by the curved shape. Due to the reduction of the piezoelectric constant, the electromechanical coupling coefficient and the dielectric constant may be reduced, thereby decreasing a capacitance. Thus, the displacement amount (or displacement width) and vibration acceleration may be reduced.

Recently, a haptic module has been developed to provide haptic feedback to a user when the user touches a screen of a display apparatus. The haptic feedback may be implemented by a vibration device. However, when haptic feedback is implemented by applying a vibration apparatus to a display apparatus having a curved shape, since the vibration apparatus has a curved shape corresponding to the curved shape of the display apparatus, it is difficult for the user to perceive the haptic feedback due to a reduction in the displacement amount (or displacement width) and vibration acceleration of the vibration apparatus caused by the curved shape.

### SUMMARY

The inventor of the present disclosure has recognized the problems and disadvantages of the related art and has performed extensive research and experiments on a vibration apparatus, in which a reduction of the piezoelectric constant and the capacitance caused by stress applied due to a curved shape may be minimized or suppressed. Based on the extensive research and experiments, the inventor of the present disclosure has invented a vibration apparatus and a method of manufacturing the same, and a flexible display apparatus and a vehicular apparatus including the vibration apparatus, in which the reduction of the piezoelectric constant and capacitance caused by stress applied due to the curved shape may be minimized or suppressed.

One or more aspects of the present disclosure are directed to providing a vibration apparatus having a curved shape and a method of manufacturing the same, and a flexible display apparatus and a vehicular apparatus including the vibration apparatus.

One or more aspects of the present disclosure are directed to providing a vibration apparatus and a method of manufacturing the same, and a flexible display apparatus and a vehicular apparatus including the vibration apparatus, in which a reduction of the piezoelectric constant and capacitance caused by stress applied due to a curved shape may be minimized or suppressed.

One or more aspects of the present disclosure are directed to providing a flexible display apparatus and a vehicular apparatus capable of outputting sound or providing haptic feedback to a user using a vibration apparatus having a curved shape.

Additional features, advantages, and aspects will be set forth in the description that follows, and in part will be apparent from the description, or may be learned by practice of the inventive concepts provided herein. Other features, advantages, and aspects of the present disclosure may be realized and attained by the structure particularly pointed out in the written description, or derivable therefrom, and the claims hereof as well as the appended drawings.

To achieve these and other advantages and aspects of the present disclosure, as embodied and broadly described herein, in one or more aspects, a vibration apparatus comprises a flexible vibration device including a piezoelectric material, and a shape-maintaining member having a curved portion coupled to a rear surface of the flexible vibration device. The flexible vibration device may be maintained in a curved shape corresponding to the curved portion of the shape-maintaining member.

In one or more aspects, a flexible display apparatus comprises a display panel configured to display an image, and a vibration generating apparatus coupled to a rear surface of the display panel and configured to vibrate the display panel. The vibration generating apparatus comprises a vibration apparatus. The vibration apparatus comprises a flexible vibration device including a piezoelectric material, and a shape-maintaining member having a curved portion coupled to a rear surface of the flexible vibration device. The flexible vibration device is maintained in a curved shape corresponding to the curved portion of the shape-maintaining member.

In one or more aspects, a vehicular apparatus comprises a dashboard having a first area facing a driver seat, a second area facing a passenger seat, and a third area between the first and second areas; an instrument panel module disposed on the dashboard; a steering wheel disposed in the first area of the dashboard; a door interior material disposed on a door; and an auxiliary display disposed at one or more of the second area of the dashboard, the steering wheel, and the door interior material, the auxiliary display having a curved surface. The auxiliary display comprises a display panel configured to display a plurality of user interface icons, and a vibration generating apparatus coupled to a rear surface of the display panel and configured to vibrate the display panel. The vibration generating apparatus comprises a vibration apparatus. The vibration apparatus comprises a flexible vibration device including a piezoelectric material, and a shape-maintaining member having a curved portion coupled to a rear surface of the flexible vibration device. The flexible vibration device is maintained in a curved shape corresponding to the curved portion of the shape-maintaining member.

In one or more aspects, a vehicular apparatus comprises a dashboard having a first area facing a driver seat, a second area facing a passenger seat, and a third area between the first and second areas; an instrument panel module disposed on the dashboard; a door interior material disposed on a door; and an auxiliary display disposed at one or more of the second area of the dashboard, a steering wheel, the door interior material, a rear surface of the driver seat, and a rear surface of the passenger seat, the auxiliary display having a curved surface. The auxiliary display comprises a display panel configured to display an image; and a vibration generating apparatus coupled to a rear surface of the display panel and configured to vibrate the display panel. The vibration generating apparatus comprises the vibration apparatus. The vibration apparatus comprises a flexible vibration device including a piezoelectric material, and a shape-maintaining member having a curved portion coupled to a rear surface of the flexible vibration device. The flexible vibration device is maintained in a curved shape corresponding to the curved portion of the shape-maintaining member.

In one or more aspects, a method of manufacturing a vibration apparatus comprises providing a flexible vibration device including a vibration layer made of a piezoelectric material, providing a shape-maintaining member having a curved portion, coupling the flexible vibration device to the curved portion of the shape-maintaining member by a coupling member, and applying a polarization voltage to the vibration layer maintained in a curved shape corresponding to the curved portion by the shape-maintaining member.

Details of other example embodiments will be included in the detailed description of the disclosure and the accompanying drawings.

An example embodiment of the present disclosure may provide a vibration apparatus having a curved shape and a method of manufacturing the same, and a flexible display apparatus and a vehicular apparatus including the vibration apparatus.

An example embodiment of the present disclosure may provide a vibration apparatus and a method of manufacturing the same, and a flexible display apparatus and a vehicular apparatus including the vibration apparatus, in which a reduction of the piezoelectric constant and capacitance caused by stress applied due to a curved shape may be minimized or suppressed.

An example embodiment of the present disclosure may provide a flexible display apparatus and a vehicular apparatus capable of outputting sound or providing haptic feedback to a user using a vibration apparatus having a curved shape.

According to one or more embodiments of the present disclosure, since a vibration part including a piezoelectric material and a signal cable may be configured as one component (or a single component), ESG (environmental, social, and governance) may be realized due to the effect of uni-materialization.

Other systems, methods, features and advantages will be, or will become, apparent to one with skill in the art upon examination of the following figures and detailed description. It is intended that all such additional systems, methods, features and advantages be included within this description, be within the scope of the present disclosure, and may be protected by the following claims and their equivalents. Nothing in this section should be taken as a limitation on those claims. Further aspects and advantages are discussed below in conjunction with aspects of the disclosure.

It is to be understood that both the foregoing description and the following description of the present disclosure are by way of example and explanatory and are intended to provide further explanation of the disclosure as claimed.

### BRIEF DESCRIPTION OF THE DRAWINGS

The accompanying drawings, which are included to provide a further understanding of the present disclosure and are incorporated in and constitute a part of this disclosure, illustrate aspects and example embodiments of the present disclosure and together with the description serve to explain principles of the disclosure. However, the technical features of embodiments of the present disclosure are not limited to those shown in the specific drawings, and the features disclosed in each drawing may be combined to form a new embodiment.

FIG. 1 is a plan view illustrating a vibration apparatus according to a first example embodiment of the present disclosure.

FIG. 2 is a cross-sectional view taken along line I-I′ illustrated in FIG. 1.

FIG. 3 is an exploded perspective view illustrating a vibration apparatus according to a first example embodiment of the present disclosure.

FIGS. 4A to 4C are diagrams illustrating a method of manufacturing a vibration apparatus according to an example embodiment of the present disclosure.

FIG. 5 is another cross-sectional view taken along line I-I′ illustrated in FIG. 1.

FIG. 6 is a cross-sectional view illustrating a flexible display apparatus according to a first example embodiment of the present disclosure.

FIG. 7 is a cross-sectional view taken along line II-II′ illustrated in FIG. 6.

FIG. 8 is another cross-sectional view taken along line II-II′ illustrated in FIG. 6.

FIG. 9 is a plan view illustrating a vehicular apparatus according to an example embodiment of the present disclosure.

FIG. 10 is a diagram illustrating a dashboard of the vehicular apparatus illustrated in FIG. 9.

FIG. 11 is a diagram illustrating a door interior material and an auxiliary display illustrated in FIG. 10.

FIG. 12 is a cross-sectional view taken along line III-III′ illustrated in FIG. 11.

Throughout the drawings and the detailed description, unless otherwise described, the same drawing reference numerals should be understood to refer to the same elements, features, and structures. The sizes, lengths, and thicknesses of layers, regions, and elements, and depiction thereof may be exaggerated for clarity, illustration, and/or convenience.

### DETAILED DESCRIPTION

Advantages and features of the present disclosure, and implementation methods thereof, are clarified through the following example aspects described with reference to the accompanying drawings. The present disclosure may, however, be embodied in different forms and should not be construed as limited to the example aspects set forth herein. Rather, these example aspects are examples and are provided so that this disclosure may be more thorough and complete to assist those skilled in the art to understand the inventive concepts without limiting the protected scope of the present disclosure.

A shape, a size, a ratio, an angle, and a number disclosed in the drawings for describing embodiments of the present disclosure are merely examples. Thus, the present disclosure is not limited to the illustrated details. Like reference numerals refer to like elements throughout, unless otherwise specified. In the following description, where the detailed description of the relevant known function or configuration may unnecessarily obscure aspects or features of the present disclosure, the detailed description of such known function or configuration may be omitted.

In a situation where terms like “comprise,” “have,” and “include” are used in describing aspects of the present disclosure, another part may be added unless a more specific term like “only” is used. The terms of a singular form can include plural forms, and vice versa, unless referred to the contrary.

In construing an element, the element should be construed as including an error range although there is no explicit description.

In describing a position relationship, for example, where a position relation between two parts is described as “on”, “over”, “under”, “next”, and “adjacent to” or the like, one or more other parts may be located between the two parts unless a more limiting term, such as “immediate(ly)”, “direct(ly)”, or “close(ly)”, is used.

For the expression that an element is “connected”, “coupled”, “contact”, or “attach” to another element, the element may not only be directly connected, coupled, or contacted to another element, but also be indirectly connected, coupled, contacted, or attached to another element with one or more intervening elements interposed between the elements, unless otherwise specified.

For the expression that an element “contacts” or “overlaps” with another element, the element can not only directly contact, overlap, or the like with another element, but also indirectly contact or overlap with another element with one or more intervening elements disposed or interposed between the elements, unless otherwise specified.

Such terms as “a first direction”, “a second direction”, “a third direction”, “X-axis direction”, “Y-axis direction”, and “Z-axis direction” should not be construed by a geometric relation only of a mutual vertical relation and may have broader directionality within the range that elements of the present disclosure may act functionally.

Features of various embodiments of the present disclosure may be partially or wholly coupled to or combined with each other and may be variously inter-operated with each other and driven technically as those skilled in the art can sufficiently understand. The embodiments of the present disclosure may be carried out independently from each other or may be carried out together in co-dependent relationship.

Hereinafter, example embodiments of the present disclosure will be described in detail with reference to the accompanying drawings. For convenience of description, a scale of each of elements illustrated in the accompanying drawings may differ from a real scale and thus is not limited to the scale illustrated in the drawings.

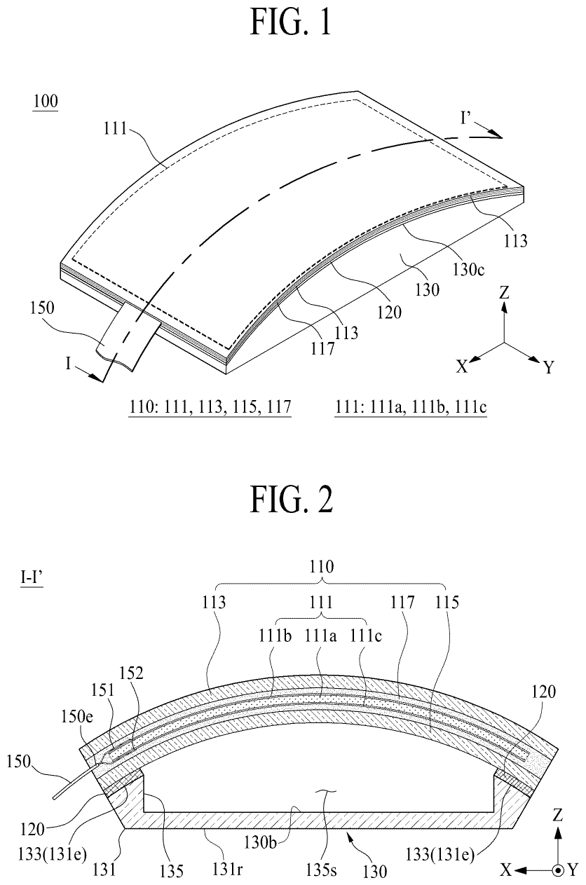

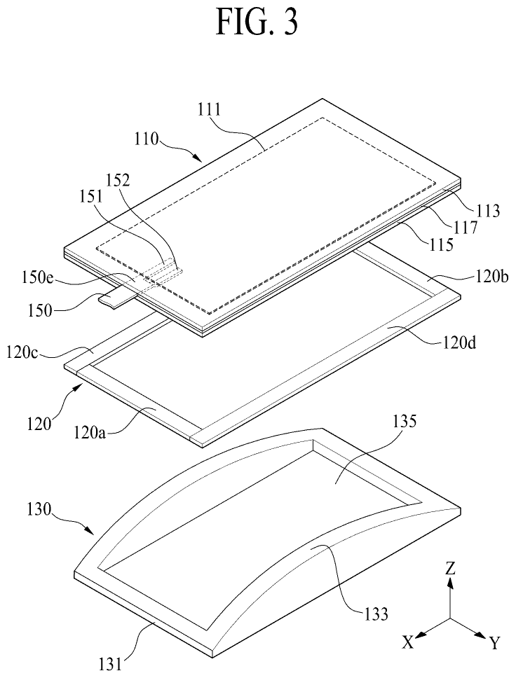

FIG. 1 is a plan view illustrating a vibration apparatus according to a first example embodiment of the present disclosure, FIG. 2 is a cross-sectional view taken along line I-I′ illustrated in FIG. 1, and FIG. 3 is an exploded perspective view illustrating a vibration apparatus according to a first example embodiment of the present disclosure.

As shown in FIGS. 1 to 3, a vibration apparatus 100 according to an example embodiment of the present disclosure may be configured or structured to output one or more of a sound, a vibration, and a haptic vibration. For example, the vibration apparatus 100 may be referred to as a flexible vibration film, a flexible actuator, a flexible piezoelectric speaker, a film actuator, a flexible sound/haptic apparatus, a flexible sound/haptic actuator, or a film-type sound/haptic actuator, or the like, but is not limited thereto.

The vibration apparatus 100 according to an example embodiment may include a flexible vibration device 110 and a shape-maintaining member 130.

The flexible vibration device 110 may include a piezoelectric material having a piezoelectric characteristic. The flexible vibration device 110 may be configured to bend into a curved shape. The flexible vibration device 110 may vibrate (or displace or be drive) based on a vibration (or displacement or driving) of the piezoelectric material in response to an electric signal (or voice signal or sound signal) applied to the piezoelectric material. For example, the flexible vibration device 110 may alternately repeat contraction and/or expansion by a piezoelectric effect (or a piezoelectric characteristic) to vibrate (or displace or drive). For example, the flexible vibration device 110 may vibrate (or displace or drive) in a vertical direction (or a thickness direction) Z as contraction and/or expansion are alternately repeated by an inverse piezoelectric effect. For example, in the flexible vibration device 110, the piezoelectric material including a piezoelectric ceramic may vibrate or mechanically displace (or vibrate or drive) in response to an electrical signal applied from the outside. For example, the flexible vibration device 110 may be a vibration generating device, a vibration film, a vibration generating film, a vibrator, an active vibrator, an active vibration generator, an actuator, an exciter, a film actuator, a film exciter, or an active vibration member, or the like, but is not limited thereto.

The flexible vibration device 110 may include a vibration part 111, a first cover member 113, and a second cover member 115.

The vibration part 111 may include a piezoelectric material or an electroactive material having a piezoelectric effect.

The vibration part 111 may include a vibration layer 111a, a first electrode layer 111b, and a second electrode layer 111c.

The vibration layer 111a may include a piezoelectric material or an electroactive material having a piezoelectric effect. For example, the vibration layer 111a may be configured as a ceramic-based piezoelectric ceramic, or may be configured as a piezoelectric ceramic having a perovskite-based crystalline structure. The piezoelectric ceramic may be configured as a single-crystal ceramic having a single-crystal structure, or may be configured as a ceramic material or polycrystalline ceramic having a polycrystalline structure. For example, the vibration layer 111a may be a piezoelectric layer, a piezoelectric material layer, an electroactive layer, a piezoelectric composite, or a piezoelectric ceramic composite, or the like, but is not limited thereto. For example, since the vibration layer 111a is formed to have a relatively thin thickness, and thus, the vibration layer 111a may be bent to have a curved shape within a specific curvature range.

The vibration layer 111a according to another embodiment of the present disclosure may include a piezoelectric composite having a flexible characteristic.

According to an example embodiment, the piezoelectric composite of the vibration layer 111a may include a plurality of piezoelectric material portions (or inorganic material portions) and a plurality of organic material portions (or flexible portions) configured to fill gaps between the plurality of piezoelectric material portions. For example, the plurality of piezoelectric material portions and the plurality of organic material portions may include a line shape or a stripe shape which has a same size or different sizes.

According to another example embodiment, the piezoelectric composite of the vibration layer 111a may include a plurality of piezoelectric material portions (or inorganic material portions) and an organic material portion (or flexible portion) disposed between the plurality of piezoelectric material portions. For example, each of the plurality of piezoelectric material portions may have a hexahedral shape and may be disposed in a lattice shape, but is not limited thereto. For example, each of the plurality of piezoelectric material portions may have a circular shape plate, an oval shape plate, or a polygonal shape plate. For example, the organic material portion may be configured to fill a gap between two adjacent piezoelectric material portions among the plurality of piezoelectric material portions or to surround each of the plurality of piezoelectric material portions, and thus, the organic material portion may be connected to or attached on the piezoelectric material portion adjacent thereto.

The plurality of piezoelectric material portions and one or more organic material portions may be disposed on (or connected to) the same plane, and thus, the vibration layer 111a according to another embodiment of the present disclosure may have a single thin film shape. Accordingly, the vibration layer 111a according to another example embodiment of the present disclosure may vibrate by the piezoelectric material portion having a vibration characteristic, and may be bent into a curved shape and have increased flexibility due to the organic material portion having flexibility.

The first electrode layer 111b may be disposed (or deposited) on a first surface (or a front surface) of the vibration layer 111a. The second electrode layer 111c may be disposed on a second surface (or a rear surface) of the vibration layer 111a different from or opposite to the first surface of the vibration layer 111a.

One or more of the first electrode layer 111b and the second electrode layer 111c may be made of a transparent conductive material, a semi-transparent conductive material, or an opaque conductive material. For example, the transparent conductive material or the semi-transparent conductive material may include indium tin oxide (ITO) or indium zinc oxide (IZO), but is not limited thereto. The opaque conductive material may include gold (Au), silver (Ag), platinum (Pt), palladium (Pd), molybdenum (Mo), magnesium (Mg), carbon, or silver (Ag) including glass frit, or the like, or may be made of an alloy thereof, but is not limited thereto.

The first cover member 113 may be disposed (or configured) at the first surface (or a front surface) of the vibration part 111. The first cover member 113 may be configured to cover the first surface (or the front surface) of the vibration part 111. For example, the first cover member 113 may be formed to have a larger size than the vibration part 111. The first cover member 113 may be configured to protect the first surface of the vibration part 111 and the first electrode layer 111b.

The second cover member 115 may be disposed (or configured) at the second surface of the vibration part 111 opposite to the first surface of the vibration part 111. The second cover member 115 may be configured to cover the second electrode layer 111c of the vibration part 111. For example, the second cover member 115 may be formed to have a larger size than the vibration part 111 and may have the same size as the first cover member 113. The second cover member 115 may be configured to protect the second surface of the vibration part 111 and the second electrode layer 111c.

The first cover member 113 and the second cover member 115 may be made of the same material or different materials. For example, each of the first cover member 113 and the second cover member 115 may be made of a plastic film, but is not limited thereto. For example, each of the first cover member 113 and the second cover member 115 may include an adhesive layer. For example, the first cover member 113 may be attached to the first surface of the vibration part 111 through the adhesive layer, and the second cover member 115 may be attached to the second surface of the vibration part 111 through the adhesive layer.

The flexible vibration device 110 may further include an adhesive member 117.

The adhesive member 117 may be disposed between the first cover member 113 and the second cover member 115 and configured to surround lateral surfaces (or side surfaces) of the vibration part 111. The adhesive member 117 may include an electrically insulating material which has adhesiveness and is capable of compression and decompression (or recovery). For example, the adhesive member 117 may include an epoxy resin, an acrylic resin, a silicone resin, or a urethane resin, but is not limited thereto.

The first cover member 113 may be coupled to the first surface of the vibration part 111 by using the adhesive member 117. The second cover member 115 may be coupled to the second surface of the vibration part 111 by using the adhesive member 117.

The vibration apparatus 100 or the flexible vibration device 110 according to an embodiment of the present disclosure may further include a signal cable 150.

The signal cable 150 may be configured to supply a vibration driving signal provided from a vibration driving circuit to the vibration part 111. The signal cable 150 may be configured to be electrically connected to the vibration part 111. The signal cable 150 may be configured to be electrically connected to the first electrode layer 111b and the second electrode layer 111c of the vibration part 111.

The signal cable 150 according to an embodiment may include a first signal line 151 electrically connected to the first electrode layer 111b of the vibration part 111, and a second signal line 152 electrically connected to the second electrode layer 111c of the vibration part 111.

The first signal line 151 may be electrically directly connected to the first electrode layer 111b of the vibration part 111 or electrically connected to the first electrode layer 111b of the vibration part 111 through a conductive tape (or a conductive pad). The second signal line 152 may be electrically directly connected to the second electrode layer 111c of the vibration part 111 or electrically connected to the second electrode layer 111c of the vibration part 111 through a conductive tape (or a conductive pad).

One side portion (or an end portion) 150e of the signal cable 150 may be accommodated (or inserted) between the first cover member 113 and the second cover member 115. For example, the one side portion (or the end portion) 150e of the signal cable 150 may be accommodated (or inserted) between one side edge of the first cover member 113 and one side edge of the second cover member 115. For example, the one side portion (or the end portion) 150e of the signal cable 150 may be inserted into the adhesive member 117 disposed between the one side edge of the first cover member 113 and the one side edge of the second cover member 115. Accordingly, the signal cable 150 may be integrated (or configured) as one body with the flexible vibration device 110 (or the vibration part 111). Therefore, the vibration apparatus 100 may be implemented in a film form integrated with the signal cable 150, thereby having the effect of uni-materialization.

The shape-maintaining member 130 may be configured or structured to maintain the flexible vibration device 110 in a curved shape. The shape-maintaining member 130 may include a curved portion 133 for maintaining the flexible vibration device 110 in the curved shape. For example, the shape-maintaining member 130 may include a curved portion 133 coupled to a rear surface of the flexible vibration device 110. Accordingly, the flexible vibration device 110 may be bent into a curved shape corresponding to the curved shape of the curved portion 133 of the shape-maintaining member 130 and may be maintained in the bent curved shape. For example, the shape-maintaining member 130 may be a supporting member, a curved supporting member, a fixing member, a shape-fixing member, or a rear member.

The shape-maintaining member 130 according to an example embodiment may be made of a plastic material, but is not limited thereto. For example, the shape-maintaining member 130 may be made of one or more of polymethyl methacrylate, polyethylene terephthalate, polycarbonate, polyimide, polypropylene, polyarylate, polyethersulfone, polyethylene naphthalate, polysulfone, cyclic-olefin copolymer, and carbon fiber reinforced plastic.

The shape-maintaining member 130 according to an example embodiment may include a body 131, a curved portion 133, and a groove portion 135.

The body 131 may have a size corresponding to a size of the flexible vibration device 110. The body 131 may have a hexahedral shape, but is not limited thereto. For example, the body 131 may include a front surface, a pair of long sides, a pair of short sides, and a rear surface 131r.

The curved portion 133 may be formed at the front surface of the body 131 to have a curved surface. The curved portion 133 may be convexly formed at the front surface of the body 131 to have a curved surface. For example, the curved portion 133 may include one or more curved surfaces. For example, the curved portion 133 may be formed to have a predetermined curvature between a pair of short sides of the body 131, or to have a plurality of curvatures between a pair of short sides of the body 131.

A distance between the rear surface 131r of the body 131 and a center of the curved portion 133 according to an embodiment may be greater than a distance between the rear surface 131r of the body 131 and an edge portion of the curved portion 133. Accordingly, the front surface of the body 131 may include a convex curved shape formed by the curved portion 133 having one or more curved surfaces.

The edge portion 131e of the curved portion 133 may be coupled to the flexible vibration device 110. For example, the edge portion 131e of the curved portion 133 may be coupled to a rear edge portion of the flexible vibration device 110. Accordingly, the flexible vibration device 110 may be bent from a planar (or flat) shape into a curved shape following the curved shape of the curved portion 133 by being coupled to the edge portion 131e of the curved portion 133 and may be maintained in the bent curved shape.

The groove portion 135 may be concavely formed from a central portion of the curved portion 133 toward the rear surface 131r of the body 131, except for the edge portion of the curved portion 133. For example, the groove portion 135 may be concavely formed in a rearward direction of the body 131 from a central portion of the curved portion 133 except for an edge portion of the curved portion 133. Accordingly, the edge portion 131e of the curved portion 133 (or a front edge portion of the body 131) may maintain or have the curved shape.

The groove portion 135 may be configured so that stress is not applied to a central portion of the flexible vibration device 110, except for the rear edge portion of the flexible vibration device 110 coupled to the curved portion 133. The groove portion 135 may be configured to provide a gap space 135s between the central portion of the flexible vibration device 110 and the body 131. An edge portion of the flexible vibration device 110 may be coupled to the edge portion of the curved portion 133, and the central portion of the flexible vibration device 110 may face a bottom surface 130b of the groove portion 135 with the gap space 135s therebetween. Accordingly, the central portion of the flexible vibration device 110, except for the rear edge portion of the flexible vibration device 110, may vibrate (or displace) freely without receiving additional stress from the gap space 135s.

The vibration apparatus 100 according to an embodiment of the present disclosure may further include a coupling member 120.

The coupling member 120 may be interposed (or coupled) between the flexible vibration device 110 and the shape-maintaining member 130. For example, the coupling member 120 may be interposed (or coupled) between the edge portion of the flexible vibration device 110 and an edge portion of the shape-maintaining member 130. The coupling member 120 may be interposed (or coupled) between the flexible vibration device 110 and the curved portion 133 of the shape-maintaining member 130. For example, the coupling member 120 may be interposed (or coupled) between the rear edge portion of the flexible vibration device 110 and the curved portion 133 of the shape-maintaining member 130.

The coupling member 120 may be configured to minimize, suppress, or prevent the vibration of the flexible vibration device 110 from being transmitted to the shape-maintaining member 130. The coupling member 120 may include a material characteristic suitable for blocking the transfer of a vibration from the flexible vibration device 110 to the shape-maintaining member 130. For example, the coupling member 120 may include a material having elasticity (or Young's modulus). For example, the coupling member 120 may include a material having elasticity for vibration absorption (or impact absorption). For example, the coupling member 120 may be configures as a material with low elasticity or a soft material. For example, the coupling member 120 may include a self-adhesive anti-vibration tape having silicone, ethylene-propylene rubber, or urethane rubber material, or comprises double-sided sponge tape, double-sided porous tape, or double-sided cushion tape.

According to an embodiment, the coupling member 120 may be ethylene-propylene rubber or urethane rubber, but is not limited thereto. For example, ethylene-propylene rubber may be an ethylene propylene diene monomer (EPDM), and may be configured as low-elasticity EPDM by varying the foaming rate in EPDM, but is not limited thereto.

The coupling member 120 according to an embodiment may have a frame shape or ring shape with a hollow portion corresponding to the groove portion 135 of the shape-maintaining member 130. The coupling member 120 may include a frame or ring shape having a width corresponding to the curved portion 133 of the shape-maintaining member 130. For example, the coupling member 120 may have a width equal to or smaller than the width of the edge portion 131e of the curved portion 133 (or the front edge portion of the body 131). Accordingly, the flexible vibration device 110 may be coupled to the curved portion 133 of the shape-maintaining member 130 by using the coupling member 120, and thus, may be bent following the curved shape of the curved portion 133. Therefore, the curved shape of the flexible vibration device 110 may be maintained or fixed by the coupling member 120.

The coupling member 120 according to another embodiment may include first to fourth coupling members 120a, 120b, 120c, and 120d.

The first coupling member 120a may have a size and shape corresponding to the curved portion 133 adjacent to a first short-side of the body 131 of the shape-maintaining member 130. The second coupling member 120b may have a size and shape corresponding to the curved portion 133 adjacent to a second short-side of the body 131. The third coupling member 120c may have a size and shape corresponding to the curved portion 133 adjacent to a first long-side of the body 131. The fourth coupling member 120d may have a size and shape corresponding to the curved portion 133 adjacent to a second long-side of the body 131. Accordingly, the flexible vibration device 110 may be coupled to the curved portion 133 of the shape-maintaining member 130 by using the first to fourth coupling members 120a, 120b, 120c, and 120d, and thus, may be bent following the curved shape of the curved portion 133. Therefore, the curved shape of the flexible vibration device 110 may be maintained or fixed by the first to fourth coupling members 120a, 120b, 120c, and 120d.

The flexible vibration device 110 or the vibration layer 111a according to an embodiment of the present disclosure may be polarized (or poled) in a state in which the flexible vibration device 110 or the vibration layer 111a is coupled to the curved portion 133 of the shape-maintaining member 130 and maintained in the curved shape. In other words, the flexible vibration device 110 or the vibration layer 111a may be polarized in a state in which the flexible vibration device 110 or the vibration layer 111a is under stress caused by the curved shape. According to an example embodiment of the present disclosure, the vibration layer 111a of the flexible vibration device 110 having the curved shape by the shape-maintaining member 130 may be polarized by a certain voltage applied to the first and second electrode layers 111b and 111c in a certain temperature atmosphere, or a temperature atmosphere that may be changed from a high temperature to a room temperature.

In the vibration apparatus 100 according to an example embodiment of the present disclosure, the flexible vibration device 110 may vibrate based on the vibration driving signal supplied from the vibration driving circuit to generate (or output) sound. Furthermore, the flexible vibration device 110 may vibrate based on a haptic driving signal supplied from the vibration driving circuit to generate (or output) haptic vibration.

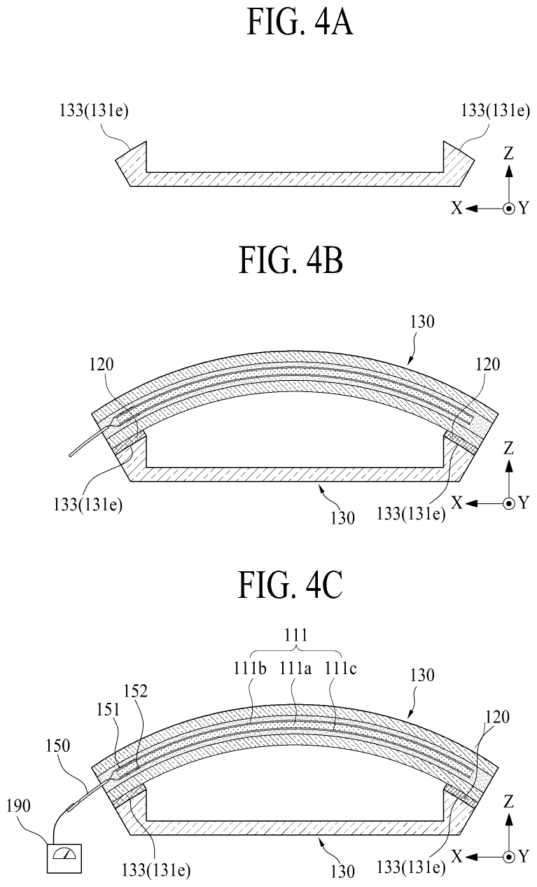

FIGS. 4A to 4C are diagrams illustrating a method of manufacturing a vibration apparatus according to an example embodiment of the present disclosure. A method of manufacturing a vibration device according to an example embodiment of the present disclosure will be described below with reference to FIGS. 4A to 4C. The descriptions of FIGS. 1 to 3 may be included in the descriptions of FIGS. 4A to 4C, and thus, repeated descriptions are omitted or will be briefly given below.

First, a flexible vibration device 110 including a vibration layer 111a made of piezoelectric material as described above with reference to FIGS. 1 to 3 is prepared.

Next, as illustrated in FIG. 4A, a shape-maintaining member 130 having a curved portion 133 is prepared.

Next, as illustrated in FIG. 4B, the flexible vibration device 110 is coupled to the curved portion 133 of the shape-maintaining member 130 by using the coupling member 120. Accordingly, the flexible vibration device 110 is bent in a curved shape corresponding to the curved portion 133 of the shape-maintaining member 130 and maintains the curved shape by the coupling member 120.

Next, as illustrated in FIG. 4C, in a certain temperature atmosphere, or a temperature atmosphere that may be changed from a high temperature to a room temperature, a polarization voltage is applied to the vibration layer 111a of the flexible vibration device 110 maintained in the curved shape corresponding to the curved portion 133 by the shape-maintaining member 130, thereby polarizing (poling) the vibration layer 111a. For example, in the polarization process, the signal cable 150 of the flexible vibration device 110 is electrically connected to a power cable of a power supply 190, and the power supply 190 may apply the polarization voltage to the first and second electrode layers 111b and 111c of the vibration part 111 through the power cable and the first and second signal lines 151 and 152 of the signal cable 150. Accordingly, the vibration layer 111a of the flexible vibration device 110 is maintained in a curved shape corresponding to the curved portion 133 by the shape-maintaining member 130, and may be polarized by a polarization voltage while in a state where stress is applied by the curved shape.

When the vibration layer 111a is polarized while in a state where stress is applied by the curved shape, due to the interaction between stress and polarization, the directionality of the residual polarization within the domain inside the piezoelectric material is strengthened in a specific direction, thereby increasing the piezoelectric constant of the vibration layer 111a. In the polarization process, when stress and polarization act simultaneously on the piezoelectric material, the direction of stress may influence polarization, allowing the polarization within the domains to be more effectively aligned. Accordingly, the piezoelectric constant of the vibration layer 111a may increase, or a decrease in piezoelectric constant due to stress caused by the curved shape may be minimized or reduced, and as a result, the electromechanical coupling coefficient and the dielectric constant may be increased or the decrease of the electromechanical coupling coefficient and the dielectric constant may be minimized or reduced, thereby increasing the capacitance or minimizing or reducing the decrease in the capacitance, and thus, the displacement amount (or displacement width) and the vibration acceleration of the vibration layer 111a may be increased or the decrease of the displacement amount (or displacement width) and the vibration acceleration of the vibration layer 111a may be minimized or reduced. Furthermore, in the polarization process, due to the interaction between stress and polarization, the polarization of the polarization within domains inside the piezoelectric material may be influenced by the direction of the stress, and thus, may be electrically anisotropic, and as a result, the dielectric constant of the piezoelectric material may increase in a specific direction, whereby the piezoelectric constant and the capacitance of the vibration layer 111a may be increased. Therefore, due to the stress applied by the curved shape, the decrease in the piezoelectric constant, the decrease in the electromechanical coupling coefficient and the dielectric constant, the decrease in capacitance, the decrease in displacement amount (or displacement width), and the decrease in vibration acceleration may be suppressed or minimized by the interaction between stress and polarization in the polarization process. In addition, the flexible piezoelectric device 110 (or vibration layer 111a) which is polarized in the state bent into a curved shape may be maintained in the curved shape by the curved portion 133 of the shape-maintaining member 130, thereby maintaining piezoelectric characteristics implemented by the polarization process.

As described above, the vibration apparatus 100 and the manufacturing method thereof according to an embodiment of the present disclosure include a flexible vibration device 110 that is polarized in a state bent into a curved shape by the curved portion 133 of the shape-maintaining member 130, and thus, a decrease in piezoelectric constant and electrostatic capacitance due to stress applied by to the curved shape may be minimized or suppressed, or the displacement amount (or displacement width) and vibration acceleration may be increased due to an increase in piezoelectric constant and capacitance.

Therefore, in the vibration apparatus 100 according to an embodiment of the present disclosure, the displacement amount (or displacement width) of the flexible vibration device 110 increases, and thus, a sound characteristic and/or a sound pressure level characteristic of a sound generated based on the displacement (or vibration) of the flexible vibration device 110 may be enhanced, and a user's perception characteristics of haptic feedback (or haptic vibration) generated based on the displacement (or vibration) of the flexible vibration device 110 may also be enhanced.

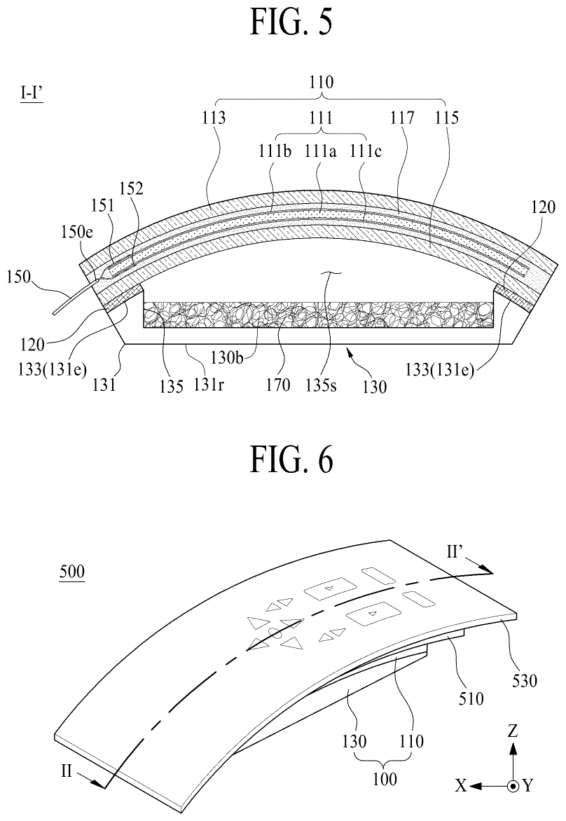

FIG. 5 is another cross-sectional view taken along line I-I′ illustrated in FIG. 1. FIG. 5 illustrates an example embodiment where a sound-absorption member is additionally configured in the vibration apparatus described above with reference to FIGS. 1 to 4C. In the following description, therefore, the sound-absorption member will be described in detail, the other elements may be substantially a same as that of descriptions described above with reference to FIGS. 1 to 4C, and thus, like reference numerals refer to like elements and repeated descriptions may be omitted or will be briefly given below.

As shown in FIGS. 1 and 5, the vibration apparatus 100 according to another example embodiment of the present disclosure may further include a sound-absorption member 170.

The sound-absorption member 170 may be disposed (or accommodated) in the groove portion 135 of the shape-maintaining member 130. The sound-absorption member 170 may be disposed (or attached) on a bottom surface 130b of the groove portion 135. For example, the sound-absorption member 170 may include a nonwoven fabric made of a plastic material. For example, the plastic material of the sound-absorption member 170 may include polypropylene or polyethylene. For example, the sound-absorption member 170 may include a nonwoven fabric made of polypropylene or polyethylene capable of sound absorption.

A portion of the groove portion 135 may be filled by the sound-absorption member 170. For example, the sound-absorption member 170 may be spaced apart from a rear surface of the flexible vibration device 110. The rear surface of the flexible vibration device 110 may face the sound-absorption member 170 with the gap space 135s therebetween.

The sound-absorption member 170 may attenuate low-frequency resonance generated at the rear surface of the flexible vibration device 110 during vibration (or displacement), thereby minimizing or reducing booming caused by interference among low frequencies and improving sound quality.

As described above, the vibration apparatus 100 according to another example embodiment of the present disclosure may provide or have the same effects as the vibration apparatus 100 according to an embodiment described above with reference to FIGS. 1 to 4C.

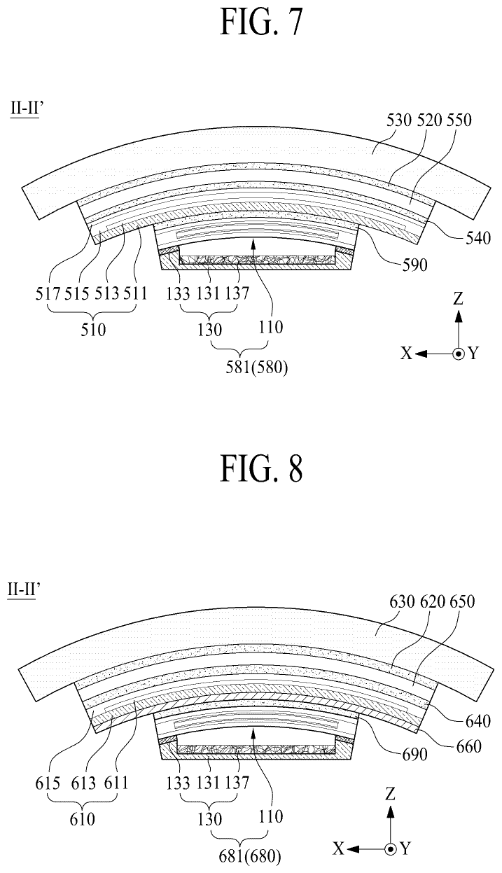

FIG. 6 is a cross-sectional view illustrating a flexible display apparatus according to a first example embodiment of the present disclosure, and FIG. 7 is a cross-sectional view taken along line II-II′ illustrated in FIG. 6.

As shown in FIGS. 6 and 7, the flexible display apparatus 500 according to a first embodiment of the present disclosure may include a display panel 510 and a vibration generating apparatus 580.

The display panel 510 may be configured to display an image (or a still image). For example, the display panel 510 may be configured to display a plurality of vehicle control icons (or user interface icons) including one or more of images, characters, figures, signs, symbols, and numerals. For example, the display panel 510 may be a smart surface display. For example, the display panel 510 may be a smart surface display panel.

The display panel 510 according to an embodiment may include a base substrate 511, a pixel array part 513 disposed (or configured) on the base substrate 511, and an optical film 517 attached to a front of the pixel array part 513.

The base substrate 511 may be made of a plastic material, but is not limited thereto.

The pixel array part 513 may include a plurality of pixel cells disposed at predetermined positions on the base substrate 511. For example, each of the plurality of pixel cells may include one or more light emitting diodes.

The optical film 517 may be disposed (or configured) to cover an entire front surface of the pixel array part 513. The optical film 517 may be attached to the front of the pixel array part 513 by using a transparent adhesive layer 515. The optical film 517 may include a plurality of vehicle control icons corresponding to the plurality of pixel cells. For example, the plurality of vehicle control icons may include one or more of images, characters, figures, signs, symbols, and numerals.

The display panel 510 may provide one or more of the plurality of vehicle control icons to a user based on light emission of one or more light emitting diodes.

The flexible display apparatus 500 according to the first embodiment of the present disclosure may further include a cover window 530.

The cover window 530 may be configured to cover a front surface of the display panel 510. For example, the cover window 530 may be attached to the front surface of the display panel 510 by using a first transparent adhesive member 520. For example, the cover window 530 may protect the display panel 510 from external impact or block impacts applied to the display panel 510. For example, the cover window 530 may be made of a transparent plastic material or a flexible glass material, but is not limited thereto.

The flexible display apparatus 500 according to the first embodiment of the present disclosure may further include a touch panel 550. The touch panel 550 may be disposed (or interposed) between the cover window 530 and the display panel 510, and may be configured to sense a user's touch on the cover window 530.

The touch panel 550 according to an embodiment may include a touch electrode layer having a plurality of touch driving lines and a plurality of touch sensing lines based on a mutual capacitance scheme. The touch panel 550 according to another embodiment may include a touch electrode layer having a plurality of touch electrodes based on a self-capacitance scheme.

The touch panel 550 may be attached to the front surface of the display panel 510 by using a second transparent adhesive member 540 and may be coupled to the cover window 530 by the first transparent adhesive member 520. For example, the cover window 530 may be attached to a front surface of the touch panel 550 by using the first transparent adhesive member 520.

The vibration generating apparatus 580 may be configured to vibrate the display panel 510. The vibration generating apparatus 580 may be attached to a rear surface of the display panel 510. The vibration generating apparatus 580 may be attached to the rear surface of the display panel 510 bay using a coupling member 590.

The vibration generating apparatus 580 may be configured or structured to output one or more of a sound, a vibration, or a haptic vibration by vibrating the display panel 510. For example, the display panel 510 may serve as a vibration member (or a vibration plate or a sound plate) which vibrates based on the driving (or vibration or displacement) of the vibration generating apparatus 580 to generate (or output) a sound and/or a vibration.

The vibration generating apparatus 580 may include a vibration apparatus 581.

The vibration apparatus 581 according to an example embodiment may be substantially the same as the vibration apparatus 100 described above with reference to FIGS. 1 to 5, and thus, repeated descriptions are omitted. Therefore, the descriptions of FIGS. 1 to 5 may be included in the descriptions of FIG. 7.

As described above with reference to FIG. 1 to 5, the vibration apparatus 581 includes a curved shape, and thus, the vibration generating apparatus 580 also includes a curved shape. Accordingly, the display panel 510 coupled with the vibration generating apparatus 580, touch panel 550, and cover window 530 may each be bent to have a curved shape corresponding to the curved shape of the vibration apparatus 581 (or the vibration generating apparatus 580). Therefore, the flexible display apparatus 500 according to the first embodiment of the present disclosure may be a curved display apparatus or a curved flexible display apparatus.

The flexible display apparatus 500 according to the first example embodiment of the present disclosure may output one or more of the sound, the vibration, or the haptic vibration based on the vibration of the display panel 510 (or cover window 530) due to the vibration (or displacement) of the vibration generating apparatus 580 including the vibration apparatus according to an example embodiment of the present disclosure described above with reference to FIGS. 1 to 5. Therefore, when outputting sound, a sound characteristic and/or a sound pressure level characteristic of a sound may be improved, and when driving haptic, a user's perception characteristics of haptic feedback (or haptic vibration) may be enhanced.

FIG. 8 is another cross-sectional view taken along line II-II′ illustrated in FIG. 6. FIG. 8 is a cross-sectional view illustrating a flexible display apparatus according to a second example embodiment of the present disclosure.

As shown in FIGS. 6 and 8, the flexible display apparatus 600 according to the second example embodiment of the present disclosure may include a display panel 610 and a vibration generating apparatus 680.

The display panel 610 may be configured to display an image. For example, the display panel 610 may be configured to display one or more of moving images, still images, and a plurality of vehicle control icons. For example, the display panel 610 may include a light emitting display or a light emitting diode display. For example, the display panel 610 may be an organic light emitting display panel.

The display panel 610 according to an example embodiment may include a base substrate 611, a pixel array part 613 disposed (or configured) on the base substrate 611, and an encapsulation portion 615 disposed (or configured) on the pixel array part 613.

The base substrate 611 may be made of a plastic material, but is not limited thereto.

The pixel array part 613 may include a plurality of pixels that display an image based on signals supplied to pixel signal lines configured on a first surface of the base substrate 611.

Each of the plurality of pixels may include a pixel circuit layer having a driving thin film transistor disposed in the pixel area provided by a plurality of gate lines and/or a plurality of data lines, an anode electrode electrically connected to the driving thin film transistor, a light emitting device layer formed on the anode electrode, and a cathode electrode electrically connected to the light emitting device layer.

The light emitting device layer may be configured to emit light of the same color for each pixel, for example, white, or may be configured to emit different colors for each pixel, for example, red, green, or blue.

The plurality of pixels (or light emitting device layer) may be configured to display an image in a bottom emission scheme, but embodiments of the present disclosure are not limited thereto. For example, the plurality of pixels (or light emitting device layer) may be configured to display an image in a top emission scheme. Light generated in the pixels based on the bottom emission scheme may pass through the base substrate 611 and may be emitted toward a forward direction of the display panel 610. Light generated in the pixels based on the top emission scheme may pass through the encapsulation portion 615 and may be emitted toward the forward direction of the display panel 610.

The encapsulation portion 615 may be configured to directly surround the pixel array part 613. The encapsulation portion 615 may be configured to prevent or block external moisture or humidity from penetrating toward the light emitting device layer. The encapsulation portion 615 may be formed of an inorganic material layer or an organic material layer, or may be formed as a multilayer structure in which inorganic and organic material layers are alternately stacked. For example, the encapsulation portion 615 may be omitted depending on a structure of the display panel 610.

The flexible display apparatus 600 according to the second example embodiment of the present disclosure may further include a cover window 630.

The cover window 630 may be configured to cover a front surface of the display panel 610. For example, the cover window 630 may be attached to the front surface of the display panel 610 by using a first transparent adhesive member 620. For example, the cover window 630 may protect the display panel 610 from external impact or block impacts applied to the display panel 610. For example, the cover window 630 may be made of a transparent plastic material or a flexible glass material, but is not limited thereto.

The flexible display apparatus 600 according to the second example embodiment of the present disclosure may further include a touch panel 650.

The touch panel 650 according to an example embodiment may be disposed (or interposed) between the cover window 630 and the display panel 610, and may be configured to sense a user's touch on the cover window 630. As an example embodiment, the touch panel 650 may include a touch electrode layer having a plurality of touch driving lines and a plurality of touch sensing lines based on a mutual capacitance scheme. As another example embodiment, the touch panel 650 may include a touch electrode layer having a plurality of touch electrodes based on a self-capacitance scheme.

The touch panel 650 may be attached to the front surface of the display panel 610 by using a second transparent adhesive member 640 and may be coupled to the cover window 630 by the first transparent adhesive member 620. For example, the cover window 630 may be attached to a front surface of the touch panel 650 by using the first transparent adhesive member 620.

The touch panel 650 according to another example embodiment may be directly formed on the encapsulation portion 615 according to an in-cell touch scheme. For example, when the light emitting device layer has the top emission scheme, the touch panel 650 may be changed to a touch electrode layer directly formed on a front surface of the encapsulation portion 615. As an example embodiment, the touch electrode layer may include a plurality of touch driving lines and a plurality of touch sensing lines based on the mutual capacitance scheme. As another example embodiment, the touch electrode layer may include a plurality of touch electrodes based on the self-capacitance scheme.

The flexible display apparatus 600 according to the second example embodiment of the present disclosure may further include a back plate 660 attached to a rear surface of the display panel 610.

The back plate 660 may be attached to a second surface of the base substrate 611 opposite to the first surface of the base substrate 611. The back plate 660 may be attached to the second surface opposite to the first surface of the base substrate 611 by using an adhesive layer. The back plate 660 may increase the rigidity of the display panel 610 and dissipate heat generated in the display panel 610. For example, the back plate 660 may be made of a metal material.

The vibration generating apparatus 680 may be configured to vibrate the display panel 610. The vibration generating apparatus 680 may be attached to the rear surface of the display panel 610. The vibration generating apparatus 680 may be attached to the rear surface of the display panel 610 by using a coupling member 400. For example, the vibration generating apparatus 680 may be attached to a rear surface of the back plate 660 by using a coupling member 690.

The vibration generating apparatus 680 may be configured or structured to output one or more of a sound, a vibration, or a haptic vibration by vibrating the display panel 610. For example, the display panel 610 may serve as a vibration member (or a vibration plate or a sound plate) which vibrates based on the driving (or vibration or displacement) of the vibration generating apparatus 680 to generate (or output) a sound and/or a vibration.

The vibration generating apparatus 680 may include a vibration apparatus 681.

The vibration apparatus 681 according to an example embodiment may be substantially the same as the vibration apparatus 100 described above with reference to FIGS. 1 to 5, and thus, repeated descriptions are omitted. Therefore, the descriptions of FIGS. 1 to 5 may be included in the descriptions of FIG. 8.

As described above with reference to FIG. 1 to 5, the vibration apparatus 681 includes a curved shape, and thus, the vibration generating apparatus 680 also includes a curved shape. Accordingly, the display panel 610 coupled with the vibration generating apparatus 680, touch panel 650, and cover window 630 may each be bent to have a curved shape corresponding to the curved shape of the vibration apparatus 581 (or the vibration generating apparatus 580). Therefore, the flexible display apparatus 600 according to the second example embodiment of the present disclosure may be a curved display apparatus or a curved flexible display apparatus.

The flexible display apparatus 600 according to the second example embodiment of the present disclosure may output one or more of the sound, the vibration, or the haptic vibration based on the vibration of the display panel 610 (or cover window 630) due to the vibration (or displacement) of the vibration generating apparatus 680 including the vibration apparatus according to an embodiment of the present disclosure described above with reference to FIGS. 1 to 5. Therefore, when outputting sound, a sound characteristic and/or a sound pressure level characteristic of a sound may be improved, and when driving haptic, a user's perception characteristics of haptic feedback (or haptic vibration) may be enhanced.

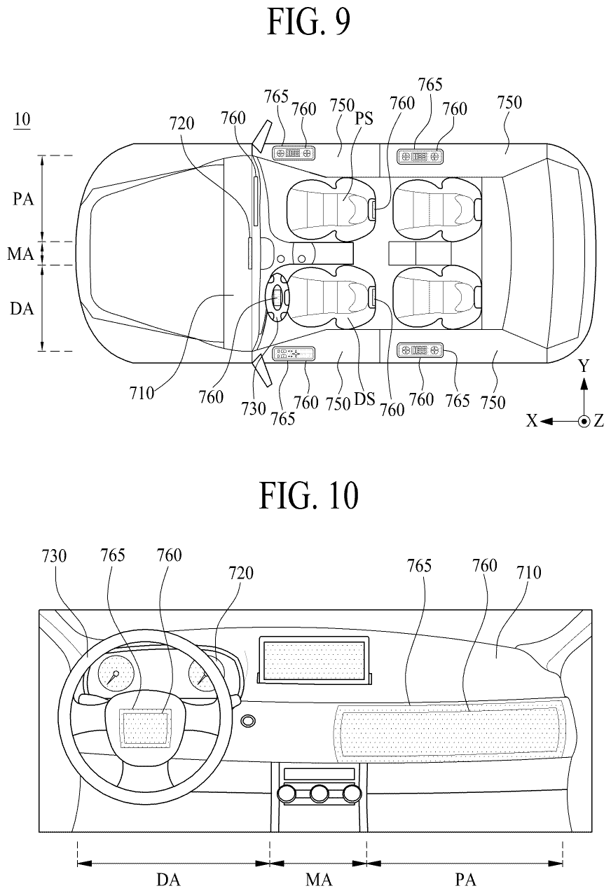

FIG. 9 is a plan view illustrating a vehicular apparatus according to an example embodiment of the present disclosure, and FIG. 10 is a diagram illustrating a dashboard of the vehicular apparatus illustrated in FIG. 9.

As shown in FIGS. 9 and 10, the vehicular apparatus 10 according to an embodiment of the present disclosure may include one or more seats DS and PS and one or more windows. For example, the vehicular apparatus 10 may include a vehicle, a train, a ship, or an aircraft, or the like.

The vehicular apparatus 10 according to an embodiment of the present disclosure may include a dashboard 710, an instrument panel module 720, a steering wheel 730, door interior materials 750, and an auxiliary display 760.

The dashboard 710 may include a first area DA facing the driver seat DS, a second area PA facing the passenger seat PS, and a third area MA between the first area DA and the second area PA.

The instrument panel module 720 may be disposed in the first area DA of the dashboard 710.

The instrument panel module 720 may include a display apparatus to provide a driver with various information such as vehicle state information and driving-related information or the like such as a velocity, fuel quantity, and engine revolutions per minute (RPM) or the like during vehicle operation. Additionally, the instrument panel module 720 may be connected to a vehicle convenience system, such as an audio system, an air conditioning system, and a multimedia system, and a navigation system which are mounted in a vehicle, and may display a control icon for controlling a corresponding vehicle convenience system and navigation information provided from a navigation system.

The steering wheel 730 may be disposed in the first area DA of the dashboard 710 to face the driver seat DS.

The door interior materials 750 may be configured to cover an inner surface of each of a driver door frame, a passenger door frame, a left rear seat door frame, and a right rear seat door frame.

The auxiliary display 760 according to an example embodiment may be disposed at one or more of the second area PA of the dashboard 710, the steering wheel 730, and the door interior materials 750, and may include a curved shape. For example, the auxiliary display 760 disposed at the second area PA of the dashboard 710 may extend from the second area PA to a part of the third area MA of the dashboard 710. For example, one or more of the second area PA of the dashboard 710, the steering wheel 730, and the door interior materials 750 may include a curved shape. The auxiliary display 760 according to an embodiment may include a curved shape corresponding to the curved shape included in one or more of the second area PA of the dashboard 710, the steering wheel 730, and the door interior materials 750.

The auxiliary display 760 according to an example embodiment may be a smart surface display, but is not limited thereto.

The auxiliary display 760 made of the smart surface display may be configured to display an image. For example, the auxiliary display 760 may be configured to display a plurality of vehicle control icons (or user interface icons) including one or more of images, characters, figures, signs, symbols, and numerals. The auxiliary display 760 may be configured to output one or more of a sound, a vibration, or a haptic vibration.

The auxiliary display 760 according to an example embodiment may be configured or structured to include the flexible display apparatus 500 according to the first example embodiment of the present disclosure described above with reference to FIGS. 6 and 7, and thus, repeated descriptions are omitted. Therefore, the descriptions of FIGS. 6 and 7 may be included in the descriptions of FIGS. 9 and 10. For example, the auxiliary display 760 may include a display panel configured to display a plurality of user interface icons, and one or more vibration generating apparatuses attached to a rear surface of the display panel, the vibration generating apparatus may include the vibration apparatus described above with reference to FIGS. 1 to 5. Furthermore, the auxiliary display 760 may further include the cover window and the touch panel described above with reference to FIGS. 6 and 7, and thus, repeated descriptions are omitted.

The auxiliary display 760 according to an example embodiment may output one or more of the sound, the vibration, or the haptic vibration based on the vibration (or displacement) of the vibration generating apparatus including the vibration apparatus 100 described above with reference to FIGS. 1 to 5. For example, the auxiliary display 760 includes the vibration apparatus 100 described above with reference to FIGS. 1 to 5, and thus, when outputting sound, a sound characteristic and/or a sound pressure level characteristic of a sound may be improved, and when driving haptic, a user's perception characteristics of haptic feedback (or haptic vibration) may be enhanced.

One or more of the second area PA of the dashboard 710, the steering wheel 730, and the door interior materials 750 where the auxiliary display 760 is disposed may include an accommodating portion concavely formed. The accommodating portion may be concavely configured or structured to accommodate the auxiliary display 760 having a curved shape.

The auxiliary display 760 according to another example embodiment may be disposed at one or more of the second area PA of the dashboard 710, the steering wheel 730, the door interior materials 750, a rear surface of the driver seat DS, and a rear surface of the passenger seat PS, and may include a curved shape. For example, one or more of the second area PA of the dashboard 710, the steering wheel 730, the door interior materials 750, the rear surface of the driver seat DS, and the rear surface of the passenger seat PS may include a curved shape. The auxiliary display 760 according to another example embodiment may include a curved shape corresponding to the curved shape included at one or more of the second area PA of the dashboard 710, the steering wheel 730, the door interior materials 750, the rear surface of the driver seat DS, and the rear surface of the passenger seat PS.

The auxiliary display 760 according to another example embodiment may be a flexible display or a curved display, but is not limited thereto. For example, the auxiliary display 760 according to another example embodiment may be an organic light emitting display apparatus or a flexible light emitting display apparatus.

The auxiliary display 760 according to another example embodiment may be configured to display an image. For example, the auxiliary display 760 may be configured to display one or more of moving images, still images, and a plurality of vehicle control icons. The auxiliary display 760 may be configured to output one or more of a sound, a vibration, or a haptic vibration.

The auxiliary display 760 according to another example embodiment may be configured or structured to include the flexible display apparatus 600 according to the second embodiment of the present disclosure described above with reference to FIGS. 6 and 8, and thus, repeated descriptions are omitted. Therefore, the descriptions of FIGS. 6 and 8 may be included in the descriptions of FIGS. 9 and 10. For example, the auxiliary display 760 may include a display panel configured to display an image, and one or more vibration generating apparatuses attached to a rear surface of the display panel, the vibration generating apparatus may include the vibration apparatus described above with reference to FIGS. 1 to 5. Furthermore, the auxiliary display 760 may further include the cover window and the touch panel described above with reference to FIGS. 6 and 8, and thus, repeated descriptions are omitted.

The auxiliary display 760 according to another example embodiment may output one or more of the sound, the vibration, or the haptic vibration based on the vibration (or displacement) of the vibration generating apparatus including the vibration apparatus 100 described above with reference to FIGS. 1 to 5. For example, the auxiliary display 760 includes the vibration apparatus 100 described above with reference to FIGS. 1 to 5, and thus, when outputting sound, a sound characteristic and/or a sound pressure level characteristic of a sound may be improved, and when driving haptic, a user's perception characteristics of haptic feedback (or haptic vibration) may be enhanced.

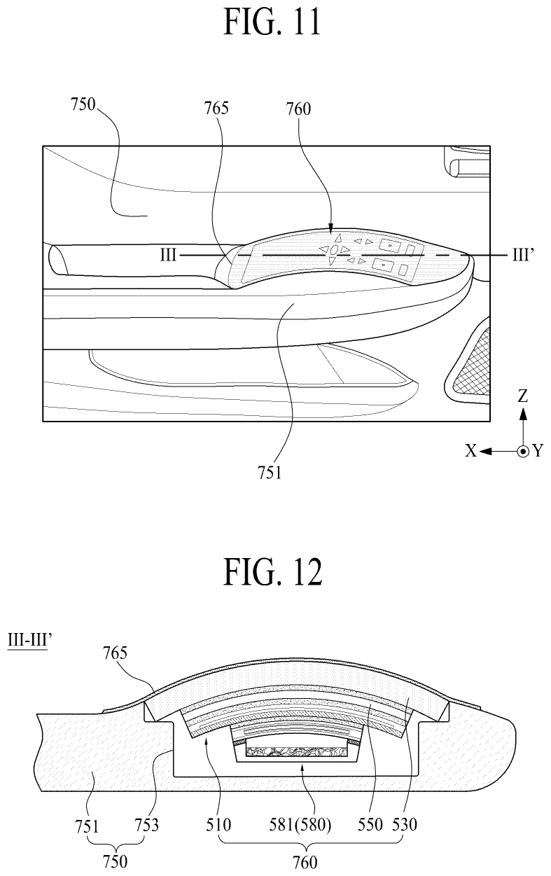

FIG. 11 is a diagram illustrating a door interior material and an auxiliary display illustrated in FIG. 10, and FIG. 12 is a cross-sectional view taken along line III-III′ illustrated in FIG. 11.

As shown in FIGS. 11 and 12, the vehicular apparatus according to an example embodiment of the present disclosure may include a door interior material 750 and an auxiliary display 760 disposed at the door interior material 750.

The door interior material 750 according to an embodiment may include a door trim bezel 751 and an accommodating portion 753.

The door trim bezel 751 may be configured or structured to have a curved shape.

The accommodating portion 753 may be concavely formed from the upper surface of the door trim bezel 751. The accommodating portion 753 may be configured to accommodate (or receive) the auxiliary display 760. For example, the accommodation portion 753 may be a groove, a groove portion, or a receiving portion.

The auxiliary display 760 may have a curved shape corresponding to the curved shape of the door trim bezel 751. The auxiliary display 760 may be configured or structured to include the flexible display apparatus 500 according to the first embodiment of the present disclosure described above with reference to FIGS. 6 and 7, and thus, repeated descriptions are omitted.

The auxiliary display 760 illustrated in FIG. 12 may be replaced with the flexible display apparatus 600 according to the second example embodiment of the present disclosure described above with reference to FIGS. 6 and 8, and thus, repeated descriptions are omitted.

The accommodating portion 753 of the door interior material 750 may be configured to support a rear edge portion of the cover window 530 of the auxiliary display 760.

The auxiliary display 760 disposed at the door interior material 750 may be configured to display vehicle control icons such as a vehicle window open icon, a vehicle window close icon, a vehicle window lock icon, a seat heating icon, and a seat cooling icon, or the like, and may be configured to output a haptic vibration corresponding to occupant's touches on the vehicle control icons.

The vehicular apparatus according to an example embodiment of the present disclosure may further include a decorative film 765.

The decorative film 765 may be configured to cover the auxiliary display 760 which is accommodated in (or into) the accommodating portion 753 of the door trim bezel 751. For example, the decorative film 765 may cover the auxiliary display 760 accommodated in the accommodating portion 753 and a periphery of the accommodating portion 753. For example, the decorative film 765 may be attached over the door trim bezel 751 and the cover window 530 of the auxiliary display 760.

The decorative film 765 according to an example embodiment may include color and patterns to improve the aesthetics of the door trim bezel 751. For example, the decorative film 765 may include wood color and wood pattern, but is not limited thereto.

The accommodating portion 753 and decorative film 765 may similarly be applied to one or more of the second area PA of the dashboard 710, the steering wheel 730, the rear surface of the driver seat DS, and the rear surface of the passenger seat PS, where the auxiliary display 760 is disposed.

As illustrated in FIG. 10, the second area PA of the dashboard 710 may include an accommodating portion concavely formed to accommodate the auxiliary display 760. The decorative film 765 may be attached on a periphery of the accommodating portion formed at the second area PA of the dashboard 710 and over the cover window of the auxiliary display 760.

As illustrated in FIG. 10, the steering wheel 730 may include an accommodating portion concavely formed to accommodate the auxiliary display 760. The decorative film 765 may be attached on a periphery of the accommodating portion formed at the steering wheel 730 and over the cover window of the auxiliary display 760.

The vehicular apparatus according to an example embodiment of the present disclosure may output one or more of a sound, a vibration, or a haptic vibration through the auxiliary display 760 including the vibration apparatus 100 described above with reference to FIGS. 1 to 5. For example, the auxiliary display 760 includes the vibration apparatus 100 described above with reference to FIGS. 1 to 5, and thus, when outputting sound, a sound characteristic and/or a sound pressure level characteristic of a sound may be improved, and when driving haptic, a user's perception characteristics of haptic feedback (or haptic vibration) may be enhanced.

The inventor of the present disclosure conducted experiments to measure the capacitance of a flexible vibration device based on a flat shape, a curved shape, and polarization order of the flexible vibration device.

The inventor of the present disclosure, as a first experimental example, measured the capacitance of a flexible vibration device polarized in a flat shape, as a second experimental example, attached the flexible vibration device of the first experimental example to a flat-shaped supporting structure and measured the capacitance of the flexible vibration device, as a third experimental example, maintained the flexible vibration device of the second experimental example in a curved shape and measured the capacitance of the flexible vibration device, as a fourth experimental example, measured the capacitance of a flexible vibration device polarized in a curved shape, and as a fifth experimental example, attached the flexible vibration device polarized with a vibration layer in the curved shape to the curved portion of the shape-maintaining member and measured the capacitance of the flexible vibration device. In the first to fifth experimental examples, the vibration layer of the flexible vibration device had a width of 60 mm and a length of 120 mm.

According to the experiments, the capacitance of the first experimental example was measured as 1.459 Cp (Capacitance in pF), the second experimental example as 1.44 Cp, the third experimental example as 1.35 Cp, the fourth experimental example as 1.48 Cp, and the fifth experimental example as 1.43 Cp.

Compared to the first experimental example, in the second experimental example, it may be seen that the capacitance decreased by approximately 0.019 pF due to stress applied by the supporting structure as the flexible vibration device polarizing the vibration layer in a flat shape is attached to the flat-shaped supporting structure.

Compared to the first experimental example, in the third experimental example, it may be seen that the capacitance decreased by approximately 0.109 pF due to stress applied by the curved shape as the flexible vibration device polarizing the vibration layer in a flat shape.

Compared to the first to third experimental examples, in the fourth experimental example, it may be seen that the capacitance increased by approximately 0.021 pF to 0.13 pF as polarization is performed in the curved shape.

In the fifth experimental example, although the capacitance of the flexible vibration device polarizing the vibration layer in a flat shape decreased compared to the fourth experimental example due to stress applied by the curved shape, but it may be seen that the capacitance is larger than that of the third experimental example. Furthermore, it may be seen that the difference (0.05 Cp) between the capacitance of the fourth experimental example and the capacitance of the fifth experimental example is smaller than the difference (0.109 Cp) between the capacitance of the first experimental example and the capacitance of the third experimental example.

Therefore, in the vibration apparatus according to an example embodiment of the present disclosure, the capacitance may increase when polarization is performed in a curved shape, and the reduction in capacitance due to stress applied by the curved shape may be minimized or suppressed. In particular, in the vibration apparatus according to an example embodiment of the present disclosure, polarization is performed on a flexible vibration device having a curved shape maintained by the shape-maintaining member, and the curved shape of the polarized flexible vibration device is maintained by the shape-maintaining member, and thus, the reduction in capacitance due to stress applied by the curved shape may be suppressed or more minimized.

It will be apparent to those skilled in the art that various modifications and variations can be made in the present disclosure without departing from the spirit or scope of the disclosures. Thus, it is intended that the present disclosure covers the modifications and variations of this disclosure provided that within the scope of the claims and their equivalents.

What is claimed is:

1. A vibration apparatus, comprising:
a flexible vibration device including a piezoelectric material; and
a shape-maintaining member having a curved portion coupled to a rear surface of the flexible vibration device,
wherein the flexible vibration device is maintained in a curved shape corresponding to the curved portion of the shape-maintaining member.

2. The vibration apparatus of claim 1, wherein the shape-maintaining member comprises:
a body;
the curved portion formed in a curved shape on a front surface of the body; and
a groove portion concavely formed in a rearward direction of the body from a central portion of the curved portion except for an edge portion of the curved portion, and
wherein the flexible vibration device is coupled to the edge portion of the curved portion.

3. The vibration apparatus of claim 2, further comprising a sound-absorption member disposed in the groove portion.

4. The vibration apparatus of claim 2, further comprising a coupling member interposed between the curved portion of the shape-maintaining member and the flexible vibration device.

5. The vibration apparatus of claim 4, wherein the coupling member comprises a self-adhesive anti-vibration tape having silicone, ethylene-propylene rubber, or urethane rubber material, or comprises double-sided sponge tape, double-sided porous tape, or double-sided cushion tape.

6. The vibration apparatus of claim 1, wherein the flexible vibration device comprises:
a vibration part including the piezoelectric material;
a first cover member covering a first surface of the vibration part;
a second cover member covering a second surface of the vibration part opposite to the first surface of the vibration part; and
an adhesive member disposed between the first cover member and the second cover member and surrounding lateral surfaces of the vibration part.

7. The vibration apparatus of claim 6, wherein the vibration part comprises:
a vibration layer including the piezoelectric material;
a first electrode layer on a first surface of the vibration layer; and
a second electrode layer on a second surface of the vibration layer different from the first surface of the vibration layer.

8. The vibration apparatus of claim 7, further comprising a signal cable electrically connected to the first electrode layer and the second electrode layer,
wherein a portion of the signal cable is accommodated between the first cover member and the second cover member.

9. A flexible display apparatus, comprising:
a display panel configured to display an image; and
a vibration generating apparatus coupled to a rear surface of the display panel and configured to vibrate the display panel,
wherein the vibration generating apparatus comprises the vibration apparatus of claim 1.

10. The flexible display apparatus of claim 9, further comprising:
a cover window covering a front surface of the display panel; and
a touch panel disposed between the cover window and the display panel and configured to sense a user's touch on the cover window.

11. The flexible display apparatus of claim 9, further comprising a cover window covering a front surface of the display panel,
wherein the display panel comprises:
a base substrate;
a pixel array part disposed on the base substrate;
an encapsulation portion covering the pixel array part;
a touch panel disposed on the encapsulation portion; and
an optical film disposed between the touch panel and the cover window.

12. A vehicular apparatus, comprising:
a dashboard having a first area facing a driver seat, a second area facing a passenger seat, and a third area between the first and second areas;
an instrument panel module disposed on the dashboard;
a steering wheel disposed in the first area of the dashboard;
a door interior material disposed on a door; and
an auxiliary display disposed at one or more of the second area of the dashboard, the steering wheel, and the door interior material, the auxiliary display having a curved surface,
wherein the auxiliary display comprises:
a display panel configured to display a plurality of user interface icons; and
a vibration generating apparatus coupled to a rear surface of the display panel and configured to vibrate the display panel, and
wherein the vibration generating apparatus comprises the vibration apparatus of claim 1.

13. The vehicular apparatus of claim 12, wherein the auxiliary display further comprises:
a cover window covering a front surface of the display panel; and
a touch panel disposed between the cover window and the display panel and configured to sense a user's touch on the cover window.

14. The vehicular apparatus of claim 12, wherein:
one or more of the door interior material, the steering wheel, and the second area of the dashboard comprises an accommodating portion concavely formed; and
the auxiliary display is accommodated in the accommodating portion.

15. The vehicular apparatus of claim 14, further comprising a decorative film covering the auxiliary display accommodated in the accommodating portion and a periphery of the accommodating portion,
wherein the auxiliary display comprises:
a cover window covering a front surface of the display panel; and
a touch panel disposed between the cover window and the display panel and configured to sense a user's touch on the cover window, and
wherein the decorative film is attached to the periphery of the accommodating portion and on the cover window.

16. A vehicular apparatus, comprising:
a dashboard having a first area facing a driver seat, a second area facing a passenger seat, and a third area between the first and second areas;
an instrument panel module disposed on the dashboard;
a door interior material disposed on a door; and
an auxiliary display disposed at one or more of the second area of the dashboard, a steering wheel, the door interior material, a rear surface of the driver seat, and a rear surface of the passenger seat, the auxiliary display having a curved surface,
wherein the auxiliary display comprises:
a display panel configured to display an image; and
a vibration generating apparatus coupled to a rear surface of the display panel and configured to vibrate the display panel,
wherein the vibration generating apparatus comprises the vibration apparatus of claim 1.

17. The vehicular apparatus of claim 16, wherein the door interior material comprises:
a door trim bezel; and
an accommodating portion concavely formed at the door trim bezel,
wherein the auxiliary display is accommodated in the accommodating portion.

18. The vehicular apparatus of claim 17, further comprising a decorative film covering the auxiliary display accommodated in the accommodating portion,
wherein the auxiliary display comprises a cover window covering a front surface of the display panel,
wherein the display panel comprises:
a base substrate;
a pixel array part disposed on the base substrate;
an encapsulation portion covering the pixel array part;
a touch panel disposed on the encapsulation portion; and
an optical film disposed between the touch panel and the cover window, and
wherein the decorative film is attached on the door trim bezel and the cover window.

19. A method of manufacturing a vibration apparatus, comprising:
providing a flexible vibration device including a vibration layer made of a piezoelectric material;
providing a shape-maintaining member having a curved portion;
coupling the flexible vibration device to the curved portion of the shape-maintaining member by a coupling member; and
applying a polarization voltage to the vibration layer maintained in a curved shape corresponding to the curved portion by the shape-maintaining member.

20. The method of claim 19, wherein the shape-maintaining member comprises:
a body;
the curved portion formed in a curved shape on a front surface of the body; and
a groove portion concavely formed in a rearward direction of the body from a central portion of the curved portion except for an edge portion of the curved portion, and
wherein the flexible vibration device is coupled to the edge portion of the curved portion by the coupling member.
